(19) United States
(12) Patent Application Publication
(10) Pub. No.: US 2010/0077886 A1
(43) Pub. Date: Apr. 1, 2010

(54) Accelerator Pedal for a Vehicle

(76) Inventors: Michael C. Seiltz, Goshen, IN (US); Michael Ross, Osceola, IN (US)

Correspondence Address: Daniel J. Deneufbourg, Esq.;CTS Corporation, 171 Covington Drive, Bloomingdale, IL, 60108, US

(21) Appl. No.: 12/565,048

(22) Filed: Sep. 23, 2009

Related U.S. Application Data
(60) Provisional application No. 61/194,312, filed on Sep. 26, 2008.

(51) Int. Cl. G05G 1/44

(52) U.S. Cl. 74/513

(57) ABSTRACT

A vehicle pedal assembly includes a pedal housing defining at least a sensor cavity and a resistance mechanism cavity accessible through an opening defined in a base of the housing. A pedal arm is coupled to the housing and includes both a sensor finger extending into the sensor cavity and a contact lever extending into the resistance mechanism cavity. A sensor is mounted in the sensor cavity and is responsive to movement of the sensor finger. A resistance mechanism is inserted and mounted in the resistance mechanism cavity through the opening in the base of the housing. The contact lever is moveable in the resistance mechanism cavity in response to movement of the pedal arm into contact with the resistance mechanism.

### CROSS REFERENCE TO RELATED APPLICATION

This application claims the benefit of the filing date and disclosure of U.S. Provisional Patent Application Ser. No. 61/194,312 filed on Sep. 26, 2008, the contents of which are entirely incorporated herein by reference as are all references cited therein.

### FIELD OF THE INVENTION

This invention relates to a pedal mechanism. In particular, the pedal may be an accelerator pedal in a vehicle.

### BACKGROUND OF THE INVENTION

Automobile accelerator pedals have conventionally been linked to engine fuel subsystems by a cable, generally referred to as a Bowden cable. While accelerator pedal designs vary, the typical return spring and cable friction together create a common and accepted tactile response for automobile drivers. For example, friction between the Bowden cable and its protective sheath otherwise reduce the foot pressure required from the driver to hold a given throttle position. Likewise, friction prevents road bumps felt by the driver from immediately affecting throttle position.

Efforts are underway to replace the mechanical cable-driven throttle systems with a more fully electronic, sensor-driven approach. With the fully electronic approach, the position of the accelerator pedal is read with a position sensor and a corresponding position signal is made available for throttle control. A sensor-based approach is especially compatible with electronic control systems in which accelerator pedal position is one of several variables used for engine control.

Although such drive-by-wire configurations are technically practical, drivers generally prefer the feel, i.e., the tactile response, of conventional cable-driven throttle systems. Designers have therefore attempted to address this preference with mechanisms for emulating the tactile response of cable-driven accelerator pedals.

In this regard, prior art systems are either too costly or inadequately emulate the tactile response of conventional accelerator pedals. Thus, there continues to be a need for a cost-effective, electronic accelerator pedal assembly having the feel of cable-based systems.

### SUMMARY

In one embodiment, the invention is directed to a pedal assembly which initially comprises a housing defining at least a first sensor cavity or chamber and a second resistance mechanism cavity or chamber. A pedal arm is coupled to the housing and has both a lever and a finger extending into the resistance mechanism cavity and the sensor cavity respectively. A sensor is mounted in the sensor cavity and responsive to movement of the pedal finger for generating an electrical signal representative of the position of the pedal arm. A resistance mechanism is mounted in the resistance mechanism cavity and the lever is adapted to contact the resistance mechanism in response to movement on the pedal arm.

In one embodiment, the sensor is a potentiometer which includes a resistor mounted on a film and a contactor mounted to a rotor coupled to the finger of the pedal arm.

In one embodiment, the housing has a third cavity and the end of the pedal arm with the lever and the finger is mounted in the third cavity.

In one embodiment, the pedal assembly also comprises a friction mechanism which is coupled between the pedal arm and the housing. The friction mechanism includes a spring coupled between the friction mechanism and the pedal arm.

In one embodiment, the resistance mechanism cavity is accessible through an opening defined in a bottom wall of the housing and the resistance device is inserted into and retained in the resistance mechanism cavity through the opening in the bottom wall of the housing. The resistance mechanism cavity is defined by a plurality of walls which includes one or more ribs which are compressed when the resistance mechanism is inserted into the resistance mechanism to retain the resistance mechanism in the resistance mechanism cavity. One or more heat stake fingers can also be used to retain the resistance device in the resistance mechanism cavity.

These and other objects, features and advantages will become more apparent in light of the text, drawings and claims.

### BRIEF DESCRIPTION OF THE DRAWINGS

In the accompanying drawings that form part of the specification, and in which like numerals are employed to designate like parts throughout the same:

FIG. 1 is an overall perspective view of an accelerator pedal assembly in accordance with the present invention;

FIG. 2 is a left side exploded perspective view of the accelerator pedal assembly of FIG. 1;

FIG. 3 is a side elevational view of the accelerator pedal assembly of FIG. 1 with the sensor cover removed;

FIG. 4 is a side elevational cross-sectional view of the accelerator pedal assembly of FIG. 1 showing inner details of the housing;

FIG. 5 is a part exploded side elevational cross-sectional view of the accelerator pedal assembly of FIG. 1 showing additional details of the housing and resistance mechanism.

FIG. 6A is a bottom plan view of the pedal housing of the accelerator pedal assembly of FIG. 1 and, more specifically, the resistance mechanism cavity therein;

FIG. 6B is a bottom plan view of the pedal housing of the accelerator pedal assembly of FIG. 1 with the resistance mechanism mounted in the resistance mechanism cavity;

FIG. 6C is a broken, vertical cross-sectional view taken along the line 6C-6C in FIG. 6B; and

FIG. 7 is a top plan view of the film containing resistor and conductor tracks of the accelerator pedal assembly of FIG. 1.

### DETAILED DESCRIPTION OF THE INVENTION

While this invention is susceptible to embodiment in many different forms, this specification and the accompanying drawings disclose one form as an example of the invention. The invention is not intended to be limited to the embodiment so described, however. The scope of the invention is identified in the appended claims.

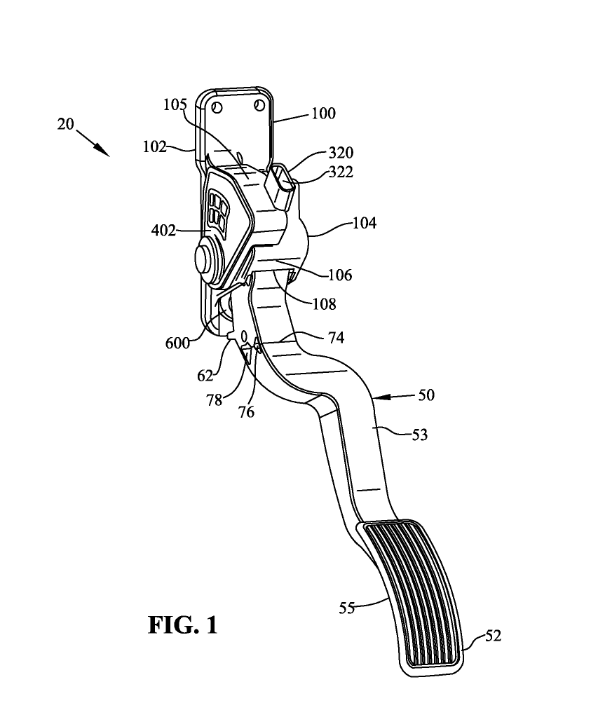

An accelerator pedal assembly 20 according to the present invention is shown in FIGS. 1-6. Pedal assembly 20 includes a pedal housing 100 and a pedal arm 50 that is rotatably mounted to the pedal housing 100. Housing 100 contains the components of the pedal assembly 20. Housing 100 is adapted for mounting to a firewall or floor of a vehicle and can be formed from molded plastic.

### Pedal Housing

Pedal housing 100 has a bottom wall or base 102 and side walls 103, 104, 105 and 106. Side walls 103 and 104 are generally parallel and opposed and oriented perpendicular to bottom wall 102 and wall 105. Several openings and cavities are defined in housing 100 as described in more detail below.

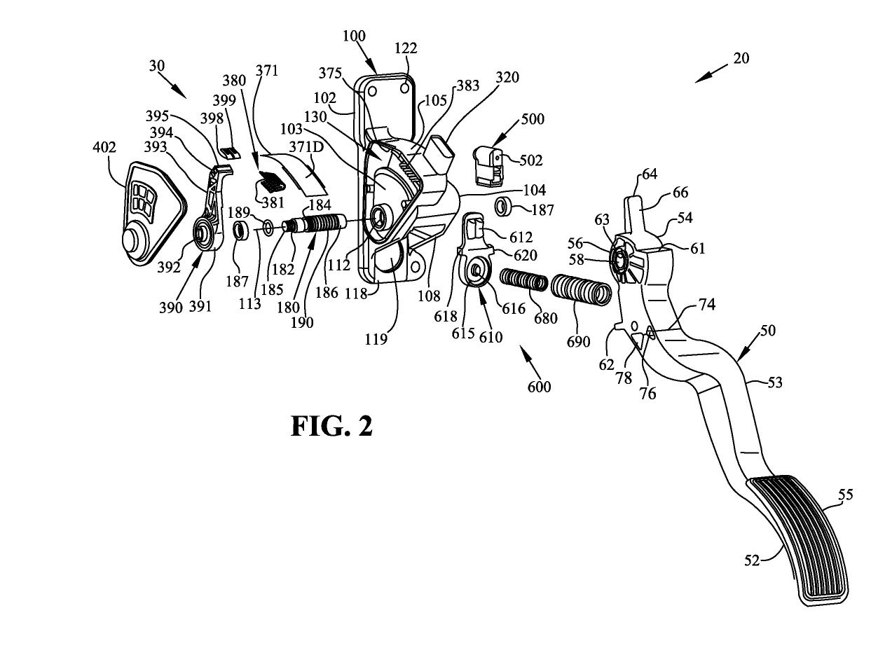

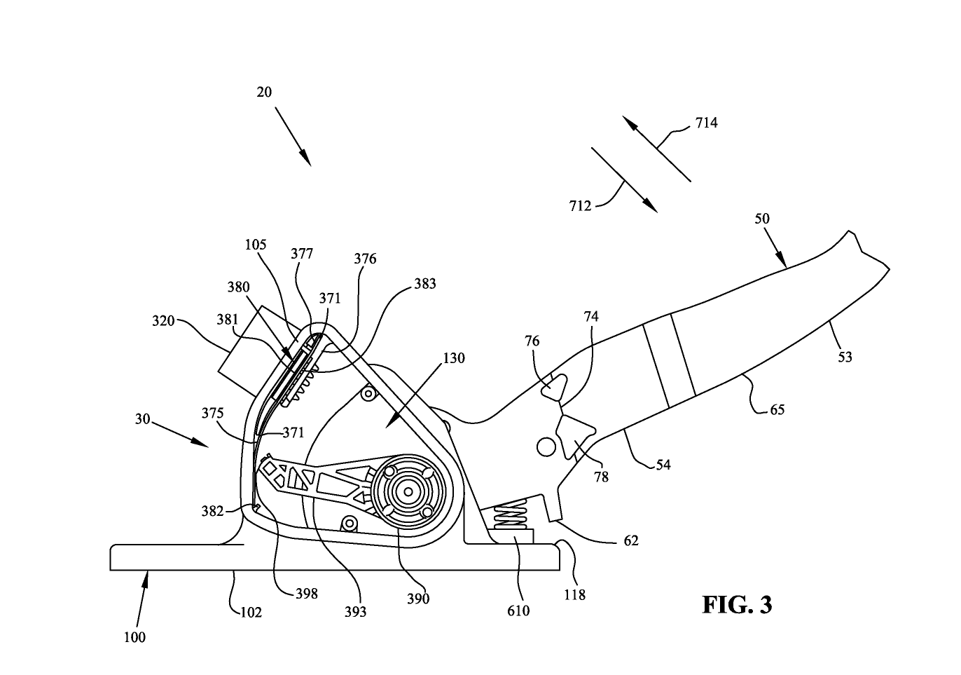

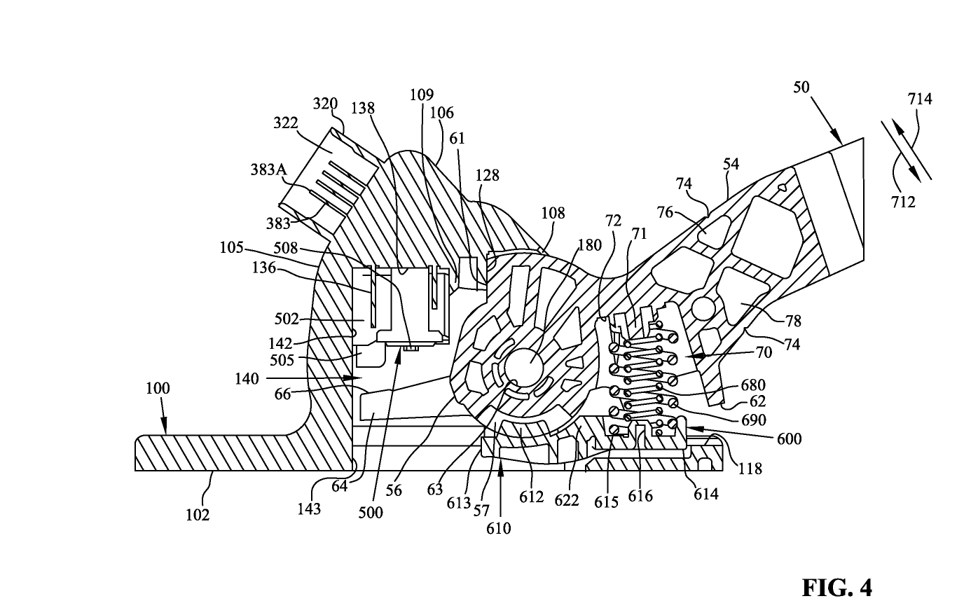

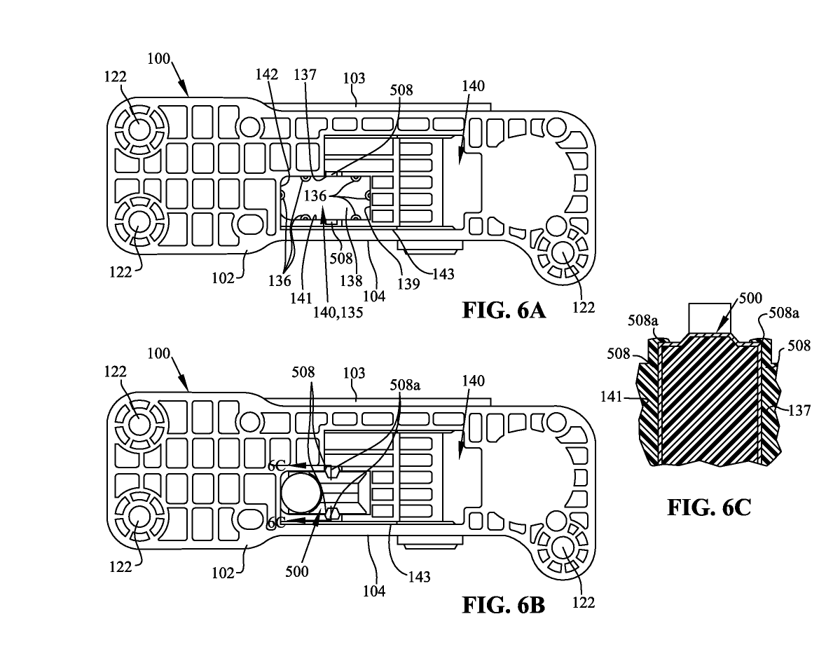

Pedal housing 100 defines an interior sensor cavity or chamber 130 (FIG. 2), an interior resistance mechanism cavity 135 (FIG. 6), and an interior pedal arm cavity or chamber 140 (FIGS. 4-6). Sensor cavity 130 is defined by bottom wall 102 and side walls 103, 105 and 106. A sensor 30 (FIGS. 2 and 3) is mounted in sensor cavity 130.

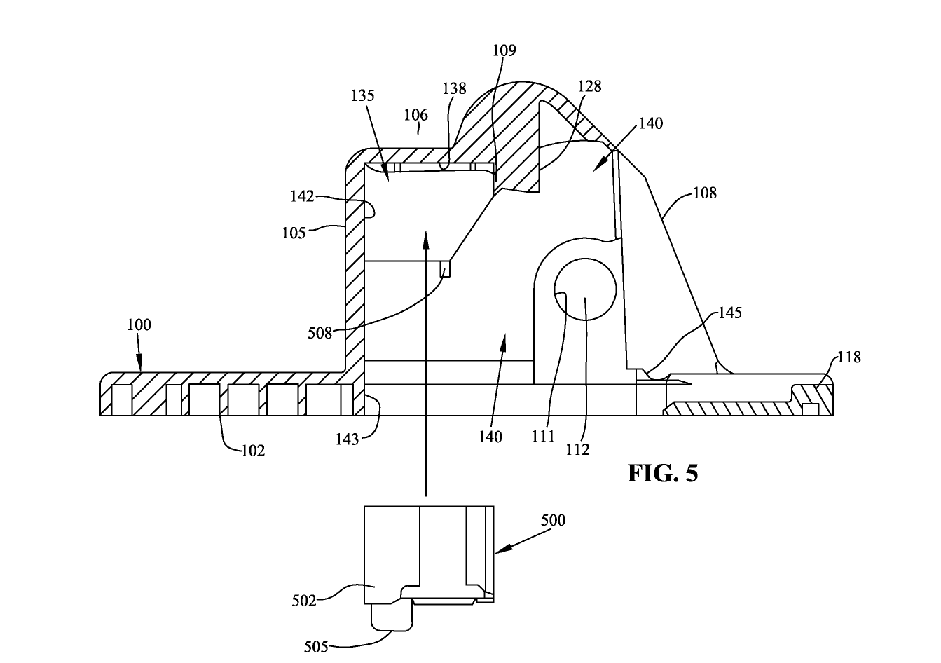

Resistance mechanism cavity 135 is defined by interior surfaces or side walls 137, 139, 141, 142, and a top interior surface or wall 138 (FIGS. 5 and 6). Walls 137 and 141 are parallel and opposed to each other. Walls 139 and 142 are parallel and opposed to each other. Resistance mechanism cavity 135 is separated from pedal arm cavity 140 by a partial wall 109 (FIG. 5) that extends downwardly from an interior surface of a top housing wall 138. Resistance mechanism cavity 135 is contiguous, connected with, and opens into, pedal arm cavity 140. Resistance mechanism cavity 135 is accessed through pedal arm cavity 140.

A resistance mechanism or kickdown device 500 (FIG. 5) is mounted in resistance mechanism cavity 135. Several elongate compression ribs 136 (FIGS. 4 and 6) protrude outwardly from the exterior face of respective interior housing walls 137, 139, 141, and 142 into cavity 135. A pair of heat stake fingers 508 extend outwardly from the exterior peripheral rim of each of the interior housing walls 137 and 141 (FIGS. 6A-6C) in a diametrically opposed relationship to each other.

Pedal arm cavity 140 is defined by bottom wall 102 and side walls 103, 104, 105 and 106 (FIGS. 5 and 6). Resistance mechanism cavity 135 faces into and is contiguous with pedal arm cavity 140. Pedal arm 50 is mounted for rotation in pedal arm cavity 140.

Pedal housing 100 further defines a rear pedal arm opening 108 (FIGS. 1 and 4) that is defined between side surfaces or walls 103 and 104, bottom wall 102 and side wall 106. Pedal arm 50 extends into pedal arm opening 108. A shaft bore 112 (FIGS. 2 and 5) extends through housing 100 in a relationship that is perpendicular to walls 103 and 104 and is parallel with an axis of rotation 113. Bore walls 111 (FIG. 5) surround shaft bore 112.

Three apertures 122 (FIGS. 6A and 6B) extend through bottom wall 102 in an orientation normal to walls 103 and 104. Housing 100 is securable to a vehicle using fasteners such as bolts or screws (not shown) that pass through apertures 122. Pedal assemblies 20 according to the present invention can mount to a firewall or pedal rack, in a relationship wherein bottom housing wall 102 is in abutting relationship with the surface of the firewall or pedal rack, by means of an adjustable or non-adjustable position pedal box rack with minor changes to the housing design.

Pedal housing 100 has a connector flange 320 (FIGS. 1-4) extending outwardly from side wall 105 and defining a terminal cavity 322 (FIGS. 1 and 4).

A ridge or lip 128 (FIG. 5) is defined within pedal arm cavity 140 adjacent to opening 108. A shallow trough 118 (FIGS. 2-4) is defined in bottom wall 102 facing toward pedal arm 50. A circular recess 119 (FIG. 2) extends through trough 118.

### Pedal

An elongated pedal or pedal arm 50 (FIGS. 1-4) has a proxil end 54 emanating from pedal arm opening 108 and a distal end 52. Center portion 53 is located between ends 52 and 54. Center portion 53 has a bottom side 65 (FIG. 3). A footpad 55 is located toward distal end 52. Footpad 55 is adapted to be depressed by the foot of a vehicle driver. Footpad 55 may be integral with the pedal arm 50 or may be articulating and rotating at its connection to end 52. Pedal arm 50 can be made from various suitable materials such as injection molded plastics.

Proxil end 54 terminates in a rounded drum 56 (FIGS. 2 and 4) that presents a curved, convex w-shaped braking surface 57 (FIG. 4). A bore 58 (FIG. 2) extends through drum 56. Bore 58 is defined by a circular bore wall 63 (FIGS. 2 and 4). When pedal 50 is mounted in housing 100, bore 58 is contiguous with bore 112 and coaxial with axis of rotation 113. An elongated resistance mechanism contact lever 64 (FIGS. 2 and 4) extends from a lower portion of drum 56 into pedal arm cavity 140 and has a flat top contact surface 66 (FIGS. 2 and 4).

Pedal arm 50 is retained to, and pivots from, pedal housing 100 via an axle or shaft 180 (FIGS. 2 and 4) that passes through drum 56. Axle or shaft 180 is cylindrical in shape and has a smaller knurled end 182, a larger opposed end 186, and a center portion 190 (FIG. 2) therebetween. Shaft 180 can be press fit into bore 58 and retained in bore 112 in a manner wherein shaft 180 is rotatably retained by housing 100.

Knurled end 182 (FIG. 2) has an annular groove 184 and several ribs 185 that are circumferentially located around end 182. An O-ring seal 189 is mounted into groove 184. Bearings 187 are mounted in bore 112 by press-fitting into bore wall 111. Shaft 180 rotates on bearings 187.

When pedal arm 50 rotates, shaft 180 is fixed to drum 56 and rotates on bearings 187. Pedal arm 50 can be rotated about axis of rotation 113.

A flat shoulder or idle stop 61 (FIGS. 2 and 4) extends from an upper portion of drum 56 and a raised rib 62 (FIGS. 2 and 4) extends from a bottom portion of pedal arm drum 56. When pedal arm 50 is released, pedal arm 50 rotates until stop 61 contacts ridge or lip 128 (FIG. 4) of housing 100 thereby limiting backward movement of pedal arm 50.

Pedal arm 50 can be depressed until it reaches another rotational limit at an open-throttle position where raised rib 62 of pedal arm 50 contacts shallow trough 118 of bottom wall 102 thereby limiting forward movement of pedal arm 50.

Pedal arm 50 further defines an interior bore 70 (FIG. 4) extending into pedal arm 50 from back surface 65. Bore 70 is adjacent to drum 56. A cylindrical post 71 (FIG. 4) extends into the bore 70 from one of the interior pedal arm surfaces 72 which define the bore 70.

Pedal arm 50 further comprises a “safe break” feature including a groove or slit or line of weakening 74 which is formed in and extends around the full circumference of the exterior surface of the pedal arm 50 and is located on the pedal arm 50 just aft of the raised rib 62 on the pedal arm 50 to create an exterior line or region of weakening on the arm 50.

In this embodiment, the “safe break” feature also comprises at least a pair of cavities or voids 76 and 78 defined in the interior of the pedal arm 50 and, more specifically, cavities or voids 76 and 78 which are formed and located in the interior of the arm 50 in a relationship and region thereof wherein the plane of the groove or slit 74 extends through the interior of the cavities or voids 76 and 78 also for the purpose of defining an interior region of weakening.

The exterior groove or slit 74 in combination with the interior cavities or voids 76 and 78 together define an intentional pedal arm stress or fracture point or riser which assures that the pedal arm 50 breaks in a safe fashion at a safe point along the length of the arm 50 in the event of a crash which results in a break of the pedal arm 50.

### Sensor

A sensor assembly 30 (FIGS. 1 and 2) is mounted to pedal assembly 20 and adapted to generate an electrical signal that represents or transmits the position of pedal arm 50. Sensor assembly 30 may, in one embodiment, comprise a contacting type sensor such as a variable resistor or potentiometer. In another embodiment, sensor assembly 30 may comprise a non-contacting type sensor that uses magnetic, capacitive or inductive technologies.

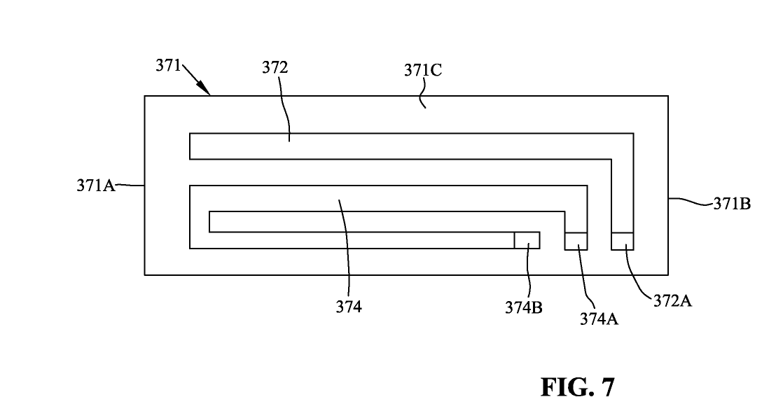

Sensor assembly 30 is mounted in sensor cavity 130 (FIGS. 2, 3, and 7). Sensor assembly 30 includes a polyimide flexible film 371 with ends 371A and 371B, a front surface 371C, and a back surface 371D. Film 371 has a resistor line or collector track 372 and an active conductor line or track 374 defined on front surface 371C. Resistor track 372 terminates in connection pad 372A and conductor track 374 terminates at opposite ends thereof in respective connection pads 374A and 374B. Film 371 is mounted in sensor cavity 130 against the exterior surface of interior housing wall 375 (FIG. 3). A separate partial wall 376 extending into sensor cavity 130 is located in front of and parallel to the wall 375. A slot 377 is defined between the walls 375 and 376. End 371B of film 371 is fitted and extends through the slot 377 in a relationship wherein the front surface 371C faces and is abutted against terminals 383. The lower end 371A is abutted against an interior step 382. A voltage can be applied between pads 374A and 374B where one of the pads 374A and 374B comprises the voltage source and the other of the pads 374A and 374B comprises ground. Pad 372A defines the output signal from the sensor.

Terminals 383 are insert molded into housing 100. The opposed ends of the terminals protrude outwardly from the slot 377 (FIG. 2). One end (FIG. 4) of the terminals is located in cavity 322 (FIG. 1) of connector shroud 320 for connection with a wire harness (not shown). The wire harness typically connects with an engine control computer which controls an electric motor attached to a throttle plate mounted on the intake of the engine. In this manner, the pedal assembly 20 is able to control the throttle setting on the engine electronically or through a wire. Systems of this type are called drive by wire systems. A metal, generally V-shaped pressure wedge 380 includes a pair of plates each including a plurality of wedge fingers 381 and is pressure fit into slot 377 to make electrical connections between resistor track 372 and one of the terminals 383, and conductor track 374 and another of the terminals 383. Wedge 380 is wedged into the slot 377 in a relationship wherein the fingers 381 on the one of the plates exert pressure against the back film surface 371D and the other of the plates exerts pressure against interior surface 375 of housing wall 105. Wedge 380 forces connection pads 372A and 374A on the front film surface 371C into electrical contact with respective ones of the terminals 383.

Rotor 390 (FIGS. 2 and 3) has a barrel or barrel-shaped portion 391 at one end. A bore 392 extends through barrel 391. An elongate sensor finger 393 extends away from barrel 391 into sensor cavity 130 and terminates in a distal finger 394 that extends normal to the finger 393. A pair of posts 395 (FIG. 1) project upwardly from finger 394. Rotor 390 is affixed on shaft 180. Shaft end 185 extends through bore 392. Shaft end 185 is then expanded by splaying or mushrooming shaft end 185 to retain rotor 390 to the shaft 180.

Rotor 390 has metal contactors or wipers 398 (FIGS. 2 and 3) attached to posts 395. Each contactor 398 has several fingers that extend away from contactors 398. During operation, as shaft 180 moves, rotor 390 is rotated. Shaft 180 is connected to pedal arm 50. Movement of pedal arm 50 causes rotor 390 and fingers 399 to move along resistor tracks 372 and conductor tracks 374. As the fingers 399 move, the output voltage or signal at terminal 372A will change and is indicative of the position of pedal arm 50.

Additional details on the operation and construction of sensor assembly 30 are detailed in U.S. Pat. Nos. 5,416,295 and 6,474,191, the contents of which are specifically herein incorporated by reference in their entirety. A sensor cover 402 (FIGS. 1 and 2) is ultrasonically welded to housing 100 to seal sensor cavity 130.

### Resistance Mechanism

As described earlier, housing 100 further defines resistance mechanism cavity or chamber 135 (FIGS. 4-6). Resistance mechanism or kickdown device 500 (FIGS. 2, 4, 5, and 6B) is mounted inside of, and retained within, cavity 135. Resistance mechanism 500 includes a housing 502 and a projecting plunger, piston or button 505.

Resistance mechanism 500 is retained within cavity 135 by press-fitting, heat staking, ultrasonic welding or other suitable retaining means. In one embodiment, housing 502 is press-fit into resistance mechanism cavity 135 with ribs 136 which protrude outwardly from the exterior surface of the walls 137, 141, 139, and 142 and are adapted to be compressed by the housing 502 of resistance mechanism 500 when resistance mechanism 500 is inserted into the cavity 135. Heat stake fingers 508 (FIGS. 6A and 6B) which extend outwardly from the top peripheral rim of the walls 137 and 141 in the direction of the bottom housing wall 102 are also deformed when heated during the assembly process to form distal tabs 508a which, as a result of heating, are bent inwardly over the top of the housing 502 to further retain resistance mechanism 500 in cavity 135.

In the embodiment of FIGS. 4 and 6A, resistance mechanism 500 is inserted in housing 100 in a relationship wherein the housing 502 of resistance mechanism 500 is located in cavity 135 defined by interior housing walls 137, 139, 141, and 142 and the plunger projects outwardly into the pedal arm cavity 140 in the direction of the bottom housing wall 102.

Resistance mechanism cavity 135 may also be defined as a recessed portion or section of top interior cavity wall 138 which is co-extensive, contiguous, connected with, and opens into, pedal arm cavity 140. Resistance mechanism cavity 135 is accessed through pedal arm cavity 140 which, in turn, is accessed through an opening 143 (FIGS. 4-6) defined in the bottom wall 102 of housing 100. Stated another way, resistance mechanism 500 is adapted to be inserted into the pedal assembly through opening 143, passed upwardly through pedal arm cavity 140, and then positioned, seated, and secured in the recess of pedal arm cavity 140 which defines the resistance mechanism cavity 135.

Because resistance mechanism cavity 135 is accessed and contiguous with pedal arm cavity 140, a separate cover or housing for resistance mechanism 500 is not required. Resistance mechanism 500 is protected by being mounted within the confines and interior of pedal housing 100.

Resistance mechanism 500 provides an increased resistance to pedal depression at a certain point in the depression of pedal arm 50. A spring mechanism (not shown) is internal to housing 502 and is coupled to button 505. Additional details on the operation and construction of resistance mechanism or kickdown device 500 are detailed in U.S. Pat. No. 6,418,813 entitled “Kickdown Mechanism for a Pedal”, the contents of which are specifically herein incorporated by reference in their entirety.

When the pedal arm 50 is near a point of maximum depression, contact surface 66 of lever 64 presses on and engages button 505 (FIG. 4). Extra force is then required to be applied to pedal arm 50 to cause button 505 to move inwardly into housing 502. Resistance mechanism 500 provides resistive feedback to the foot of the pedal operator and provides an indication that the pedal is near a maximum point of depression. The maximum point of pedal depression can correspond to a wide open engine throttle position or can be used to indicate a downshift point for an automatic transmission. It is noted that contact surface 66 and lever 64 only contact button 505 of resistance mechanism 500 near a point of maximum pedal depression.

In another embodiment, resistance mechanism 500 may be omitted from resistance mechanism cavity 135. In this example, pedal assembly 20 still operates in the same manner except that the increase in resistance to pedal depression at the end of travel of the pedal arm 50 is no longer present. Pedal assembly 20 therefore may be used with or without resistance mechanism 500 resulting in a flexible pedal design in which one design can be used for several different pedal applications.

### Friction Generating Assembly

A friction generating assembly 600 is shown in FIGS. 2 and 4. Friction generating assembly 600 is mounted in friction generating assembly cavity 140 (FIG. 5) and includes a brake pad 610 and springs 680 and 690.

Brake pad 610 receives springs 680 and 690 at one end and contact drum 56 at the other end. Brake pad 610 is pivotally mounted to housing 100 such that a contact surface 612 is urged against w-shaped braking surface 57 on the drum 56 as pedal arm 50 is depressed.

Brake pad 610 comprises a W-shaped contact surface 612, a distal end 613, and an opposed proximal end 614. A circular recess or socket 615 is defined in proximal end 614. A post 616 protrudes outwardly and upwardly from the base of the brake pad 610 and into the center of recess 615. Contact surface 612 is W-shaped and is located at end 613. Contact surface 612 includes a plurality of contact surfaces that define a W-shape. W-shaped braking surface 57 on drum 56 of pedal arm 50 includes a plurality of braking surfaces. Contact surfaces 612 on brake pad 610 are adapted to mate with braking surfaces 57 on the drum 56 to form friction generating mechanism or assembly 600.

Brake pad 610 also has opposed posts, arms, or trunnions 618 and 620 (also called outriggers or flanges) which define a primary pivot axis 622. Contact surface 612 of brake pad 610 is situated on one side of pivot axis 622 and socket 615 for receiving one end of spring 680 and 690 is provided on the other side of primary pivot axis 622.

Spring 690 is larger in diameter than spring 680. Springs 680 and 690 are co-axial, with spring 680 being located inside spring 690. Springs 680 and 690 provide redundancy, i.e., in case one of the springs fails, the other is able to operate. One end of respective springs 680 and 690 extends into and through the bore 70 in the underside of the proximal end 54 of pedal arm 50 with post 71 in bore 70 extending through the center of inner spring 680. The other end of respective springs 680 and 690 are retained in socket 615 with post 616 extending into the center of inner spring 680.

Contact surface 612 on brake pad 610 is substantially complementary to braking surface 57 on drum 56. In one embodiment, contact surface 612 is curved and w-shaped with a substantially constant radius of curvature. In alternate embodiments, braking surface 612 has a varying radius of curvature and other shapes. The frictional engagement between contact surface 612 and braking surface 57 may tend to wear either surface. The shape of contact surface 612 may be adapted to reduce or accommodate wear.

Housing 100 is provided with spaced slots or grooves 145 (FIG. 5) for slidably receiving the posts or trunnions 618 and 620 on brake pad 600. Trunnions 618 and 620 are substantially cylindrical in shape. Brake pad 612 pivots about the trunnions 618 and 620 seated in respective slots or grooves 145.

As pedal arm 50 is moved as shown in FIGS. 3 and 4 in a first direction 712 (accelerate) or the other direction 714 (idle or decelerate), the force within compression springs 680 and 690 increases or decreases, respectively. Brake pad 610 is moveable in response to the spring force.

As pedal arm 50 moves towards the accelerate position (direction 712), brake pad 610 pivots to increase the force urging contact surface 612 on brake pad 610 into the braking surface 57 on drum 56. As pedal arm 50 moves towards the decelerate position (direction 714), brake pad 610 pivots to decrease the force urging contact surface 612 into braking surface 57.

Additional details on the operation and construction of friction generating assembly 600 are detailed in U.S. Patent Publication No. 2007/0137400 entitled “Accelerator Pedal for a Vehicle”, the contents of which are specifically herein incorporated by reference in their entirety for related and supportive teachings.

### CONCLUSION

Numerous variations and modifications of the embodiment described above may be effected without departing from the spirit and scope of the novel features of the invention. It is to be understood that no limitations with respect to the specific system illustrated herein are intended or should be inferred. It is, of course, intended to cover by the appended claims all such modifications as fall within the scope of the claims.

What is claimed is:

1. A pedal assembly comprising:
a housing defining at least a first cavity and a second cavity;
a pedal arm coupled to the housing, the pedal arm having an end with a lever;
a sensor mounted in the first cavity and responsive to movement of the pedal arm for generating an electrical signal representative of the position of the pedal arm; and
a resistance mechanism mounted in the second cavity, the lever being adapted to contact the resistance mechanism in response to movement of the pedal arm.

2. The pedal assembly in accordance with claim 1 wherein the sensor is a potentiometer.

3. The pedal assembly in accordance with claim 2 wherein the potentiometer includes a resistor mounted on a film and a contactor mounted to a rotor.

4. The pedal assembly in accordance with claim 3 wherein the pedal arm has an elongate sensor finger extending into the first cavity and the rotor is coupled to the sensor finger.

5. The pedal assembly in accordance with claim 1 wherein a friction mechanism is at least partially mounted in the housing.

6. The pedal assembly in accordance with claim 1 wherein the pedal arm includes a drum at one end, the housing defining a third cavity and the drum of the pedal arm being located in the third cavity.

7. A pedal assembly comprising:
a housing defining a sensor chamber, a resistance device chamber, and a pedal arm chamber;
a pedal arm rotatably coupled to the housing, the pedal arm having a first end located within the pedal arm chamber and a second end extending from the housing;
a resistance device mounted in the resistance device chamber; and
a sensor mounted in the sensor chamber, the sensor being responsive to movement of the pedal arm for providing an electrical signal that is representative of a position of the pedal arm.

8. The pedal assembly in accordance with claim 7 wherein a friction mechanism is coupled between the pedal arm and the housing.

9. The pedal assembly in accordance with claim 8 wherein a spring is coupled between the friction mechanism and the pedal arm.

10. A pedal assembly comprising:
a housing defining an interior cavity accessible through an opening defined in a base of the housing; and
a resistance device adapted to be inserted into and retained in the interior cavity of the housing through the opening in the base of the housing.

11. The pedal assembly in accordance with claim 10 wherein the interior cavity is defined by a plurality of walls including one or more ribs which are compressed when the resistance device is inserted into the interior cavity.

12. The pedal assembly in accordance with claim 10 wherein one or more heat stake fingers retain the resistance device in the interior cavity of the housing.

13. The pedal assembly in accordance with claim 10 further comprising a pedal arm including a rotatable drum extending into the interior cavity of the housing, the rotatable drum having a lever extending into the interior cavity, the resistance device including a plunger and the lever contacting the plunger in response to movement of the pedal arm.

14. The pedal assembly in accordance with claim 10 wherein the housing includes a top wall having an interior surface, the interior cavity being defined in part by the interior surface of the top wall and the resistance device abutting against the interior surface of the top wall and extending inwardly into the interior cavity.
